(19) United States
(12) Patent Application Publication
(10) Pub. No.: US 2024/0151526 A1
(43) Pub. Date: May 9, 2024

(54) ADD-ON FOR A SPIRIT LEVEL

(71) Applicant: Stefan KOLITSCH, Döbeln (DE)

(72) Inventor: Stefan KOLITSCH, Döbeln (DE)

(21) Appl. No.: 18/280,873

(22) PCT Filed: Mar. 8, 2022
(86) PCT No.: PCT/DE2022/100184

§ 371 Date: Sep. 7, 2023

(30) Foreign Application Priority Data
Mar. 24, 2021 (DE) 10 2021 107 367.7

(51) Int. Cl. G01C 9/26; B25H 7/04

(52) U.S. Cl. CPC G01C 9/26; B25H 7/04

(57) ABSTRACT

The invention relates to an add-on for a spirit level, designed as a marking aid for indicating and as a marking instrument for marking the position of drilled holes for mounting objects on a wall, wherein the add-on is fastened releasably on a spirit level and is arranged to be movable along the longitudinal axis of this spirit level. The object of the invention is that an add-on of this kind be designed in such a way that, during alignment, a spirit level equipped with this add-on bears fully on the associated wall and that the elements of the add-on that are necessary for a marking come into operational contact with the wall only temporarily. This object is achieved by the fact that the add-on has a pin head, a double U-shaped middle part and a fastening part for connection to the spirit level, with specific designs being proposed for these assemblies.

### CROSS-REFERENCE TO RELATED APPLICATIONS

This application is a U.S. National Phase Application under 35 U.S.C 371 of International Application No. PCT/DE2022/100184, filed on Mar. 8, 2022, which claims the benefit of German Patent Application No. 10 2021 107 367.7, filed on Mar. 24, 2021. The entire disclosures of the above applications are incorporated herein by reference.

### FIELD

The present invention relates to an add-on for a spirit level, designed as a marking aid for indicating and as a marking instrument for marking the position of drill holes for mounting objects on a wall, wherein the add-on is fastened releasably on a spirit level and is arranged to be movable along the longitudinal axis of this spirit level.

### BACKGROUND

This section provides background information related to the present disclosure which is not necessarily prior art.

Regardless of their specific design, spirit levels have a cuboid base body with two narrow sides, two wide sides and two end faces. At least one narrow side is designed as a planar contact surface. At least one wide side and one end face are equipped with a horizontal and a vertical measuring module, respectively, for which so-called bubble levels are usually used. Thus, different types of objects can advantageously be aligned both horizontally and vertically.

Generic spirit levels come in almost endless varieties and often feature add-ons for specific objects or measuring tasks. For example, EP 2 744 055 A1 describes a spirit level with a marking template for aligning power outlets and similar assemblies. The subject matter of DE 20 2010 000 689 U1 is a spirit level with a template for mounting urinals.

In a spirit level according to DE 102 19 936 A1, the base body is provided with apertures which can be used to make markings on a wall. Marking drill holes and the like for mounting objects on a wall is an essential application of spirit levels. Other proposed solutions for this are known, for example, from DE 197 49 026 A1, DE 198 10 716 A1, DE 10 2010 044 225 A1 and DE 20 2007 007 119 U1.

Despite the large number of known designs, there is still a need for development. This applies in particular to applications where the user has to apply at least two markings at a distance from each other in one plane on a wall. Such work is necessary, for example, for an assembly of wall cabinets and shelves or for hanging large wall paintings. For an exact subsequent assembly position, both tasks of a marking aid (indicating the position similar to a template) and tasks of a marking instrument (indicating or marking the position) must be fulfilled.

DE 195 01 383 A1 describes a scribing device for a spirit level with two pin holders. Here, each pin holder has a spring unit that presses a pen-shaped object against a stop formed on the pin holder to secure it. Both pin holders can be moved independently and are equipped with a spirit level element.

A spirit level with an elongated channel to which a rail is attached is known from U.S. Pat. No. 7,513,056 B1. Several sleeves are movably mounted on this rail, in each of which a marking instrument is arranged.

The subject matter of DE 200 04 419 U1 is a spirit level with a carriage that has a holder for holding a writing tool. The carriage is connected to a means of conveyance that can be driven by an electric motor.

Finally, DE 101 54 574 A1 describes a marking tool for various marking tasks. In its basic variant, the tool does not have a cuboid base body, but two separate legs that are connected to each other at a pivot point and can be positioned at different angles to each other. One version of the basic variant is modified in such a way that a spirit level module is attached to one leg. Furthermore, two marking tips are guided on the leg as an add-on, each of which can be clamped by a spring and loosened by compressing the spring as well as moved on the leg. A user can hold the two marking tips, and thus the entire tool, with his hands and align them while looking at the spirit level module. Then, with his hands resting on the marking tips, the user marks the respective position on the assigned wall by pressing down on these marking tips. In this regard, it is proposed as one embodiment that the marking tips are pressed into an ink pad before being applied to the wall. Thus, easily recognizable color imprints are created on the wall, which mark the position of the subsequent drill holes.

However, this technical solution has significant disadvantages: The marking tips constantly protrude from the contour of the spirit level module, such that only these elements rest on the wall during alignment and not the entire base body. This can cause damage to the wall if the tool is moved over this wall when aligning with the marking tips. In addition, the support in only two points achieved in this way does not ensure stable support on the wall. Another disadvantage is the need for an additional ink pad to make the mark.

### SUMMARY

This section provides a general summary of the disclosure, and is not a comprehensive disclosure of its full scope or all of its features.

It is the object of the invention to provide an add-on for a spirit level which is suitable as a marking aid and as a marking instrument. In this case, the spirit level equipped with such an add-on should rest fully on the assigned wall during alignment, and the elements of the add-on required for marking should only come into operative contact with the wall temporarily.

This task is solved in that the add-on has a pen head, a double U-shaped middle part, and a fastening part for connection to the spirit level. The pen head has a cuboid base body, in the longitudinal direction of which a continuous recess is arranged to accommodate a marking element. A spring is arranged in this recess in such a way that the marking element is subjected to a spring force in the opposite direction to the wall to be marked and, on the end face opposite the wall, protrudes with a partial section from the pen head, which is closed off with a lid. One side surface of the base body has a longitudinal gap in which a web contour designed on or attached to the marking element is guided in such a way that the path of the marking element is limited. Square cutouts are arranged on two opposite side surfaces of the base body, in each of which a section of a locking bolt with the same contour is mounted. The square section of each locking bolt features a cylindrical section. This section is mounted in a cutout congruent therewith on one leg each at the front end section of the one fork-shaped recess of the double U-shaped middle part in such a way that the pen head is pivotably supported on the double U-shaped middle part. The fastening part is mounted on the other fork-shaped recess of the double U-shaped middle part so that it can be moved longitudinally. For this purpose, the fastening part has a cutout on each of its two outer surfaces running in the longitudinal direction of the double U-shaped middle part, which cutouts guide surface sections of the fork-shaped recess with the same contour. The fastening part also has a bore running in the longitudinal direction of the double U-shaped middle part, in which a screw bolt is guided, the thread contour of which engages in a thread contour congruent therewith on a central section next to the one fork-shaped recess of the double U-shaped middle part.

An advantageous design is that the recess running longitudinally in the pen head is cylindrical in shape to accommodate a pen-shaped marking element with a circular cross section.

Another advantageous design is that the spring arranged in the recess of the pen head is supported on a web contour below the marking element and applies a spring force to an oblique or web-like contour of the marking element. Thus, a positionally stable arrangement and easy operability are achieved for the marking element.

Another advantageous design is that the web contour, which is designed on or fastened to the marking element as a path boundary, is formed by a ring arranged on the marking element and a slider guided in the longitudinal gap. Thus, a positionally fixed path limitation for the marking element is achieved.

Another advantageous design results from the fact that a spring is arranged in each of the square cutouts of the pen body, which applies a spring force to the end face of the locking bolt aligned with the pen body. This ensures good positional fixation and easy handling when the position of the pen head is changed.

The technical features explained above create an add-on for a spirit level, which is suitable as a marking aid and as a marking instrument. The actual marking process is implemented in a similar way to “stamping,” in that two movable pins are used to apply markings to a wall in a functionally similar way to a stamp. These elements, which are necessary for marking, are only temporarily in operative contact with the wall. In comparison with the previously known prior art, two new approaches in particular are thus implemented, which are described below under “A” and “B”:

A) A pen with a rotatable and lockable pen head for attachment to spirit levels by the following structure and function sequence:

Square cutouts are arranged in the struts of the middle part inside and the pivoting pen head, matching the square bottom part of the locking bolts. In addition, round cutouts are arranged on the outside of the struts of the middle part, matching the round upper part of the locking bolts. The locking bolts are spring-loaded, such that they are pressed and held in the square cutout of the middle section in a straight position and rotated through 90°. By pressing the locking bolts together, the square lower part of the locking bolt is pressed completely into the cutout of the pen head. In addition, the movable pen lead is pushed forward. The pen head can thus be rotated 90° until the locking bolts lock again in the square cutout of the middle part. On the other side of the middle part, there are two smaller web contours that are designed as a guide for the fastening part. The fastening part is attached to the middle part via a screw connection with the screw bolt. Provided the pen head is aligned straight, the marking element can be used as a common pen. Provided the pen head is rotated 90°, the marking element can be attached to the spirit level via the fastening part and the screw bolt.

B) Movable pen lead through which the user can create a mark when pressing down with a finger by the following structure and function sequence:

The pen lead is movably mounted in the pen head. A ring with a slider, with which the pen lead can be moved in the pen head, is located approximately in the middle of the axial extension of the pen lead. The ring keeps the pen lead in the pen head and prevents it from falling out. The pen head is guided through the lid at the top and through the round cutout at the bottom, through which only the pen lead fits. In addition, there is a spring between the ring and the bottom part. If the pen head is in a 90° rotated position, the pen lead is pushed back by the spring until it disappears into the contour of the pen head. This prevents a protruding pen lead from contaminating the wall or ceiling when aligning the spirit level. By pressing down the pen lead with the finger, the pen lead is guided out of the pen head, and the mark can be created. A significant advantage here is that the user can hold the spirit level with both hands at all times, as marking can be performed with just one finger. In addition, there is a round cutout in the middle part for the pen lead. When the pen head is aligned straight, the pen lead is pressed into this cutout by the spring and provides even more grip.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

From the exemplary embodiment shown in the drawing, the structure of an add-on according to the invention can be seen, with which the functional effects explained above can be achieved. Wherein:

FIG. 1 shows the basic structure in perspective view

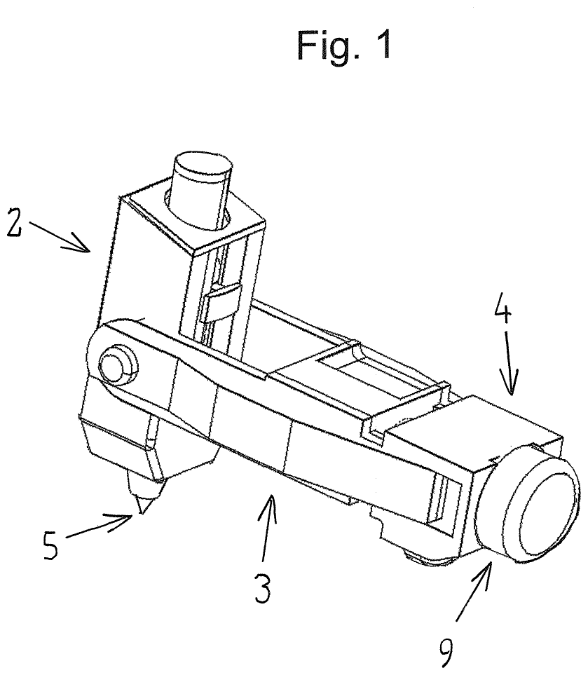

FIG. 2 shows the basic structure in exploded view

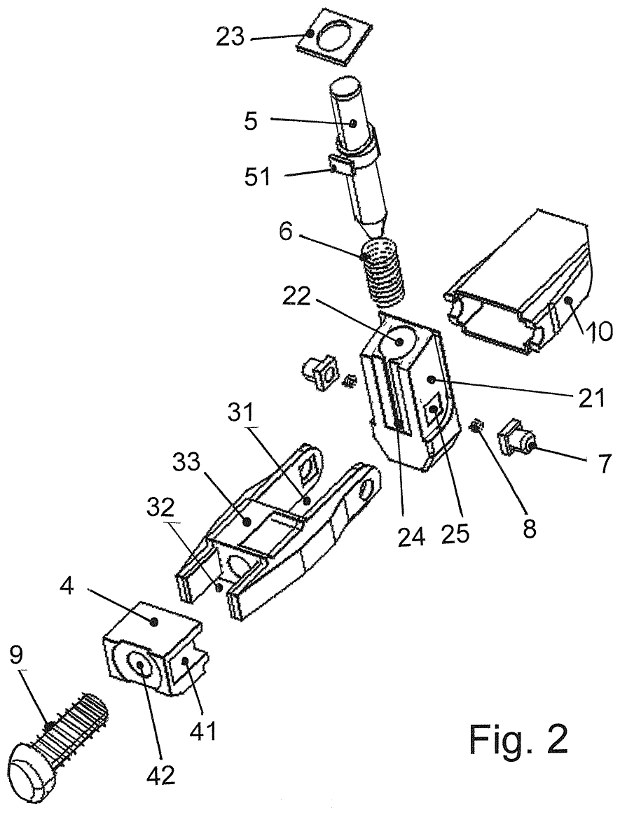

FIG. 3 shows the arrangement of two add-ons on a spirit level

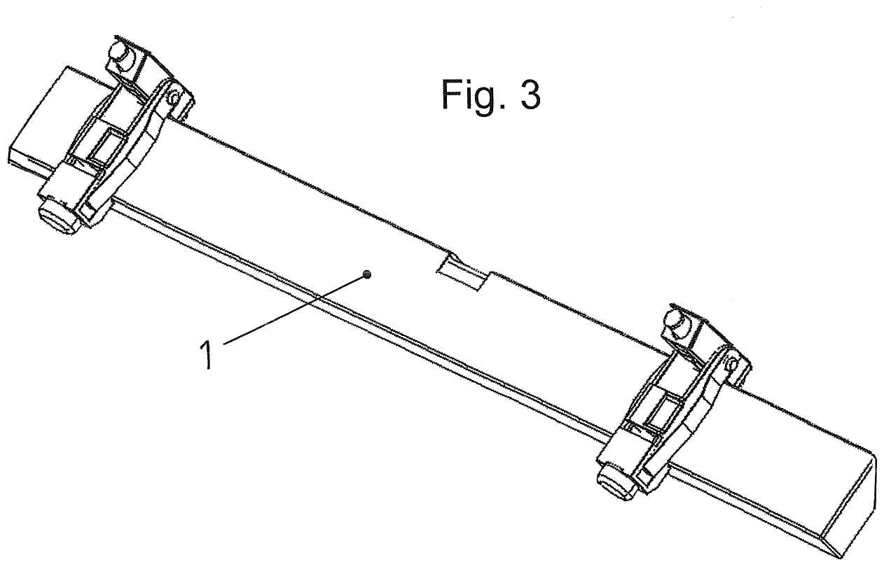

### DETAILED DESCRIPTION

Example embodiments will now be described more fully with reference to the accompanying drawings.

The device shown in the drawing is preferably designed for marking the position of drill holes for mounting objects on a wall. For this purpose, the device is designed as an add-on that is releasably mounted on a spirit level 1 and is arranged to be movable along the longitudinal axis of said spirit level 1.

This add-on has a pen head 2, a double U-shaped middle part 3, and a fastening part 4 for connection to the spirit level 1. The pen head 2 has a cuboid base body 21, in the longitudinal direction of which a continuous recess 22 is arranged to receive a marking element 5. In the embodiment shown in the drawing, the recess 22 is cylindrical in shape, so that a pen-shaped marking element 5 with a circular cross section can be used here.

A spring 6 is arranged in the recess 22 in such a way that the marking element 5 is subjected to a spring force against the wall to be marked (not shown). For this purpose, the spring 6 is supported, for example, with an end section on a web contour below the marking element 5 and applies a spring force to an oblique or web-like contour of the marking element 5. At the end opposite the wall, a section of the marking element 5 protrudes from the pen head 2, which is closed off with a lid 23.

One side surface of the base body 21 has a longitudinal gap 24, in which a web contour 51 designed on or attached to the marking element 5 is guided in such a way that the path of the marking element 5 is limited. The web contour 51 can be designed in various ways, for example by a ring arranged on the marking element 5 with a slider guided in the longitudinal gap 24. The longitudinal gap 24 is preferably formed on the side surface of the base body 21, which is aligned with the interior of the one fork-shaped recess 31 of the double U-shaped middle part 3. Thus, the movement of the web contour 51 to limit the travel of the marking element 5 takes place in a free installation space, without the risk of colliding with other components.

Square cutouts 25 are arranged on two opposite side surfaces of the base body 21, in each of which a section of a locking bolt 7 having the same contour is mounted. The square section of each locking bolt 7 features a cylindrical section. These cylindrical sections are mounted in a cutout congruent therewith on one leg each at the front end section of the one fork-shaped recess 31 of the double U-shaped middle part 3 in such a way that the pen head 2 is pivotably supported on the double U-shaped middle part 3. A spring 8 is arranged in each of the square recesses 25 of the pen body 2, which applies a spring force to the end face of the locking bolt 7 aligned with the pen body 2.

The fastening part 4 is mounted longitudinally movably on the other fork-shaped recess 32 of the double U-shaped middle part 3. In this case, the fastening part 4 has a cutout 41 on each of its two outer surfaces running in the longitudinal direction of the double U-shaped middle part 3, which cutouts guide surface sections of the fork-shaped recess 32 with the same contour.

Furthermore, the fastening part 4 has a bore 42 extending in the longitudinal direction of the double U-shaped middle part 3, in which a screw bolt 9 is guided. The thread contour of the screw bolt 9 engages in a thread contour congruent therewith at a middle section 33 adjacent to the fork-shaped recess 32 of the double U-shaped middle part 3.

If an appropriately set up add-on is to be used, for example, when hanging a shelf with two screws on a wall, the center of the shelf is detected. Starting from the center of the shelf, two add-ons are attached symmetrically to this point on the base body of the spirit level 1, such that a template is functionally created. This work step is not carried out on the wall, but preferably on a firm base, such that a very exact determination of the desired distance of the subsequent drill holes is possible. Then the spirit level 1 equipped with two add-ons is held against the wall and aligned under observation of the bubble level. Subsequently, the drill holes are marked by pressing down the marking elements 5 with one finger in each add-on.

The foregoing description of the embodiment has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An add-on for a spirit level, designed as a marking aid for indicating and as a marking instrument for marking the position of drill holes for mounting objects on a wall, wherein the add-on is fastened releasably on a spirit level and is arranged to be movable along the longitudinal axis of this spirit level,
wherein the add-on has a pen head, a double U-shaped middle part and a fastening part for connection to the spirit level, wherein the pen head has a cuboid base body, in the longitudinal direction of which a continuous recess for receiving a marking element is arranged, wherein a spring is arranged in the recess in such a way that the marking element is acted upon by a spring force against the wall to be marked and, at the end face opposite to the wall, projects with a partial section from the pen head, which is closed off by a lid, wherein one side face of the base body has a longitudinal gap in which a web contour designed on or fastened to the marking element is guided in such a way that the path of the marking element is limited, wherein square cutouts are arranged on two opposite side faces of the base body, in each of which cutouts a section of a locking bolt having the same contour is mounted, wherein the respective square section of each locking bolt features a cylindrical section which is mounted in a cutout congruent therewith on a respective leg at the front end section of the one fork-shaped recess of the double U-shaped middle part in such a manner that the pen head is pivotably supported on the double U-shaped middle part, wherein the fastening part is longitudinally movably mounted on the other fork-shaped recess of the double U-shaped middle part, wherein the fastening part has, on its two outer surfaces running in the longitudinal direction of the double-U-shaped middle part, in each case one recess in which surface sections of the fork-shaped recess having the same contour are guided, and wherein the fastening part has a bore running in the longitudinal direction of the double-U-shaped middle part, in which bore a screw bolt is guided, the thread contour of which engages in a thread contour congruent therewith on a middle section next to the fork-shaped recess of the double U-shaped middle part.

2. The add-on for a spirit level according to claim 1, wherein the recess extending in the longitudinal direction in the pen head is designed in the shape of a cylinder for receiving a pen-shaped marking element having a circular section.

3. The add-on for a spirit level according to claim 1, wherein the spring arranged in the recess of the pen head is supported on a web contour below the marking element and applies a spring force to an oblique or web-like contour of the marking element.

4. The add-on for a spirit level according to claim 1, wherein the web contour designed on or fastened to the marking element as a path limit is designed by a ring arranged on the marking element and a slider guided in the longitudinal gap of the base body by the pen head.

5. The add-on for a spirit level according to claim 1, wherein a spring is arranged in each of the square cutouts of the pen head, which spring applies a spring force to the end face of the locking bolt aligned with the pen body.

6. A marking apparatus releasably attachable to a spirit level and movable along a longitudinal axis of the spirit level, comprising:
a pen head;
a double U-shaped middle part; and
a fastener portion configured to attach the marking apparatus to the spirit level;
wherein the pen head comprises a cuboid base body extending in a longitudinal direction, the base body comprising a continuous recess;
wherein a marking element is received in the recess;
wherein a spring is disposed in the recess and configured to bias the marking element against a wall to be marked;
wherein an end face of the marking element opposite to a marking tip of the marking element projects from the pen head;
wherein the pen head is closed off by a lid;
wherein one side face of the base body has a longitudinal gap;
wherein a guide element is attached to the marking element and slides along the gap, limiting movement of the marking element along the longitudinal direction;
wherein square cutouts are arranged on two opposite side faces of the base body;
wherein locking bolt comprising a square portion is mounted in each of the cutouts;
wherein the respective square portion of each locking bolt comprises a cylindrical section which is mounted in a cutout congruent therewith on a respective leg at the front end section of a first fork-shaped recess of the double U-shaped middle part in such a manner that the pen head is pivotably supported on the double U-shaped middle part;
wherein the fastener portion is longitudinally movably mounted on a second fork-shaped recess of the double U-shaped middle part;
wherein each of two outer surfaces of the fastener portion comprises a recess extending in the longitudinal direction and within which respective surface sections of the second fork-shaped recess are guided; and
wherein the fastener portion comprises a bore extending in the longitudinal direction, and wherein a male-threaded bolt is received in the bore, and wherein the male threads of the bolt engage female threads in a middle section of the double U-shaped middle part next to the second fork-shaped recess.
